(19) United States
(12) Patent Application Publication
(10) Pub. No.: US 2026/0320815 A1
(43) Pub. Date: Oct. 15, 2026

(54) BIOMETRIC ASSESSMENT

(71) Applicant: KING'S COLLEGE LONDON, Greater London (GB)

(72) Inventors: Lorenzo VENTURINI, London (GB); Joseph Vilmos HAJNAL, London (GB); Samuel BUDD, London (GB); Alfonso FARRUGGIA, London (GB); Robert WRIGHT; Jacqueline MATTHEW, London (GB); Emily SKELTON, London (GB)

(21) Appl. No.: 19/481,851

(22) PCT Filed: May 10, 2024
(86) PCT No.: PCT/GB2024/051231

§ 371 Date: Nov. 5, 2025

(30) Foreign Application Priority Data
May 11, 2023 (GB) 2306961.0

(51) Int. Cl. G06T 7/60; G06T 7/00; G06V 10/25; G06V 10/82; G06V 20/64

(52) U.S. Cl. CPC G06T 7/60; G06T 7/0012; G06V 10/25; G06V 20/653; G06T 2207/10132; G06T 2207/20076; G06T 2207/20084; G06T 2207/30004; G06T 2207/30168; G06V 10/82; G06V 2201/03

(57) ABSTRACT

Imaging data processing methods and apparatus to process imaging data and computer program products configured to perform image data processing. One aspect provides an apparatus to: acquire measurement data relating to a feature of interest from imaging data representative of a three-dimensional object comprising the feature of interest; model measurement data distribution as a superposition of: a truth distribution of imprecise measurement of the feature of interest, and a noise distribution; assume a first shape for the truth distribution and a second shape for the noise distribution; and estimate a probability distribution of a measurement of the feature of interest based on the modelled measurement data. Arrangements described provide a method of using or processing imaging data collected in relation to a 3-dimensional object including one or more features or elements of interest such that an indication of a representative “true” value of an associated dimension can be determined.

### FIELD OF THE INVENTION

The present invention relates to imaging data processing methods, apparatus to process imaging data and computer program products.

### BACKGROUND

Image processing is known. Typically, an imaging device or sensor images an object and provides image data which provides a representation of the object. That image data may be reviewed to identify elements and characteristics of those elements of the object. Although image processing techniques exist to assist in identifying elements and characteristics of those elements forming an object, they each have their own shortcomings. Accordingly, it is desired to provide improved image processing techniques.

### SUMMARY

According to some, but not necessarily all, embodiments, there is provided: an apparatus comprising: at least one processor; and at least one memory storing instruction which, when executed by the at least one processor, cause the apparatus at least to: acquire measurement data relating to a feature of interest from imaging data representative of a three-dimensional object comprising the feature of interest; model measurement data distribution as a superposition of: a truth distribution of imprecise measurement of the feature of interest, and a noise distribution; assume a first shape for the truth distribution and a second shape for the noise distribution; and estimate a probability distribution of a measurement of the feature of interest based on the modelled measurement data. Accordingly, this aspect recognises that, based upon a set of measurement data comprising a plurality of measurements of the feature of interest, it is possible to derive an indication of a “true” value for that measurement based on a probability distribution of the measurements forming the set of measurement data. In other words, from imaging data, it is possible to determine an accurate indication of a feature or structure of interest which appears in such imaging data. Such an approach can provide a more reproducible and objective measurement of a feature of interest. Accordingly, the apparatus may acquire measurement data relating to a feature of interest from imaging data representative of a three-dimensional object comprising the feature of interest. The measurement data relating to the feature of interest may comprise “raw” data. The measurement data may comprise pre-processed data. In either case, the measurement data may be modelled as having a measurement data distribution which is a superposition of: a truth distribution of imprecise measurement of the feature of interest, and a noise distribution. The noise distribution may comprise any aspect or element of the measurement data which is not directly attributable to the measurement of interest, that is to say, it comprises any unwanted disturbance in a measurement. That disturbance may result from a range of factors, for example, interference or similar. Noise is herein used as a general bucket for anything that is not the feature of interest. The apparatus may be configured to assume a first shape for the truth distribution and a second shape for the noise distribution. The first and second shapes may be different. The apparatus may be configured to estimate a probability distribution of a measurement of the feature of interest based on the modelled measurement data. The apparatus may begin with an initial guess for the first and second shape and be configured to adjust or iterate such initial guesses as each measurement forming the measurement data is processed.

According to some embodiments, the measurement data relates to a biometric of the feature of interest from imaging data representative of a three-dimensional object comprising the feature of interest. In relation to biometric features and associated measurement, an ability to evaluate the biometric objectively, rather than subjectively, may have an impact if the biometric is typically used, for example, in making a clinical decision or diagnosis.

According to some embodiments, the apparatus is configured to estimate a measurement of the feature of interest based upon the estimated probability distribution of measurements of the feature of interest based on the modelled measurement data, the measurement being derived from a peak value derived from the estimated probability distribution. In other words, the true value of a measurement may be represented by a central measurement of an inferred probability distribution.

According to some embodiments, the apparatus is configured to estimate a measurement of the feature of interest based upon the estimated probability distribution of measurements of the feature of interest based on the modelled measurement data, the measurement being derived from a central measurement of the estimated probability distribution.

According to some embodiments, the truth distribution of imprecise measurement of the feature of interest has a first shape modelled as a Gaussian distribution around the measurement. It will be appreciated that other probability distributions for the truth distribution may be appropriate, based upon, for example, a characteristic or nature of the measurement or biometric being assessed and/or an imaging technique used to acquire the imaging data. By way of example, the distribution may comprise: a projection through a multivariate Gaussian; the distribution may comprise: a sum of Gaussians (for example, for a feature that has several contributing estimators only one of which is of interest: e.g. estimating femur length to avoid competition from shorter arm or leg bones). Furthermore, the distribution could be a skewed distribution, for example, in femur estimation the distribution of estimates is unlikely to be symmetrical.

According to some embodiments, the measurement may comprise a final measurement of the feature of interest. According to some embodiments, the measurement may comprise an intermediate measurement of the feature of interest based upon a current estimated probability distribution.

According to some embodiments, the noise distribution is attributable to data from misclassified features, having a second shape modelled as a uniform distribution over a search space. It will be appreciated that other probability distributions for the noise distribution may be appropriate, based upon, for example, a characteristic or nature of the measurement or biometric being assessed and/or an imaging or image data processing technique used to acquire the imaging data.

According to some embodiments, the apparatus is configured to estimate a probability distribution of a measurement of the feature of interest based on the modelled measurement data by calculating, for each measurement sample of the measurement data, a posterior probability of the measurement sample belonging to either of the truth distribution or noise distribution.

According to some embodiments, an estimate of the truth distribution is updated based on a likelihood of a measurement sample of the measurement data being a true measurement.

According to some embodiments, the apparatus is configured to perform Bayesian estimation in relation to the truth distribution and probability distribution.

According to some embodiments, relative weights of the truth and noise distribution can be adjusted or updated. Such an adjustment or update may be selected based upon the nature of the imaging data.

According to some embodiments, the apparatus is configured to estimate a probability distribution of a measurement of the feature of interest based on the modelled measurement data by applying a Bayesian inference approach.

According to some embodiments, the apparatus is configured to analyse the acquired measurement data and discard or downweight any measurement which falls outside a preselected range associated with the feature of interest.

According to some embodiments, analysing the acquired measurement data comprises: filtering some measurement data from a data measurement set to remove discard or downweight any measurement that represents an improbable measurement of the feature of interest.

According to some embodiments, any measurement within the acquired measurement data outside of a range [a, b], where a and b are lower and upper bounds of a range selected in dependence upon the feature of interest, is discarded without further processing.

According to some embodiments, rather than discard a measurement in the measurement data, the measurement may be downweighted.

According to some embodiments, the downweighting may depend upon the magnitude or extent to which a measurement is outside the preselected range.

According to some embodiments, the measurement data comprises measurement of a biometric relating to a feature of interest in ultrasound imaging data.

According to some embodiments the apparatus is configured to acquire measurement data by analysing one or more image of the feature of interest obtained from the imaging data representative of the three dimensional object.

According to some embodiments, the one or more image comprises: a standard frame obtained from ultrasound imaging data.

According to some embodiments, the apparatus is configured to recognise one or more measurement anchor in an image comprising the feature of interest and determine a measurement of the feature of interest from the one or more recognised measurement anchor.

According to some embodiments, the apparatus is configured to use a neural network trained to recognise the one or more measurement anchor in the image comprising the feature of interest.

According to some, but not necessarily all, embodiments, there is provided: a method comprising: acquiring measurement data relating to a feature of interest from imaging data representative of a three-dimensional object comprising the feature of interest; modelling measurement data distribution as a superposition of: a truth distribution of imprecise measurement of the feature of interest, and a noise distribution; assuming a first shape for the truth distribution and a second shape for the noise distribution; and estimating a probability distribution of a measurement of the feature of interest based on the modelled measurement data.

According to some embodiments, the measurement data relates to a biometric of the feature of interest from imaging data representative of a three-dimensional object comprising the feature of interest.

According to some embodiments, the method comprises estimating a measurement of the feature of interest based upon the estimated probability distribution of measurements of the feature of interest based on the modelled measurement data, the measurement being derived from a peak value derived from the estimated probability distribution.

According to some embodiments, the apparatus is configured to estimate a measurement of the feature of interest based upon the estimated probability distribution of measurements of the feature of interest based on the modelled measurement data, the measurement being derived from a central measurement of the estimated probability distribution.

According to some embodiments, the measurement may comprise a final measurement of the feature of interest. According to some embodiments, the measurement may comprise an intermediate measurement of the feature of interest based upon a current estimated probability distribution.

According to some embodiments, the truth distribution of imprecise measurement of the feature of interest has a first shape modelled as a Gaussian distribution around the measurement.

According to some embodiments, the noise distribution is attributable to data from misclassified features, having a second shape modelled as a uniform distribution over a search space.

According to some embodiments, the method comprises estimating a probability distribution of a measurement of the feature of interest based on the modelled measurement data by calculating, for each measurement sample of the measurement data, a posterior probability of the measurement sample belonging to either of the truth distribution or noise distribution.

According to some embodiments, an estimate of the truth distribution is updated based on a likelihood of a measurement sample of the measurement data being a true measurement.

According to some embodiments, the method comprises performing Bayesian estimation in relation to the truth distribution and probability distribution.

According to some embodiments, relative weights of the truth and noise distribution can be adjusted or updated.

According to some embodiments, the method comprises estimating a probability distribution of a measurement of the feature of interest based on the modelled measurement data by applying a Bayesian inference approach.

According to some embodiments, the method comprises analysing the acquired measurement data and discarding any measurement which falls outside a preselected range associated with the feature of interest.

According to some embodiments, analysing the acquired measurement data comprises: filtering some measurement data from a data measurement set to remove any measurements that represent an improbable measurement of the feature of interest.

According to some embodiments, any measurement within the acquired measurement data outside of a range [a, b], where a and b are lower and upper bounds of a range selected in dependence upon the feature of interest, is discarded without further processing.

According to some embodiments, the measurement data comprises: measurement of a biometric relating to a feature of interest in ultrasound imaging data.

According to some embodiments, the method comprises acquiring measurement data by analysing one or more image of the feature of interest obtained from the imaging data representative of the three dimensional object.

According to some embodiments, the one or more image comprises: a standard frame obtained from ultrasound imaging data.

According to some embodiments, the method comprises: recognising one or more measurement anchor in an image comprising the feature of interest and determine a measurement of the feature of interest from the one or more recognised measurement anchor.

According to some embodiments, the method comprises: using a neural network trained to recognise the one or more measurement anchor in the image comprising the feature of interest.

According to some embodiments, the method comprises analysing the acquired measurement data and discard any measurement which falls outside a preselected range associated with the feature of interest.

According to some, but not necessarily all, embodiments, there is provided: a computer program product operable, when executed on a computer, to acquire measurement data relating to a feature of interest from imaging data representative of a three-dimensional object comprising the feature of interest; model measurement data distribution as a superposition of: a truth distribution of imprecise measurement of the feature of interest, and a noise distribution; assume a first shape for the truth distribution and a second shape for the noise distribution; and estimate a probability distribution of a measurement of the feature of interest based on the modelled measurement data.

According to some, but not necessarily all, embodiments, there is provided: an apparatus comprising: means configured to acquire measurement data relating to a feature of interest from imaging data representative of a three-dimensional object comprising the feature of interest; means configured to model measurement data distribution as a superposition of: a truth distribution of imprecise measurement of the feature of interest, and a noise distribution; means configured to assume a first shape for the truth distribution and a second shape for the noise distribution; and means configured to estimate a probability distribution of a measurement of the feature of interest based on the modelled measurement data.

According to some, but not necessarily all, embodiments, there is provided: an apparatus comprising: circuitry configured to acquire measurement data relating to a feature of interest from imaging data representative of a three-dimensional object comprising the feature of interest; circuitry configured to model measurement data distribution as a superposition of: a truth distribution of imprecise measurement of the feature of interest, and a noise distribution; circuitry configured to assume a first shape for the truth distribution and a second shape for the noise distribution; and circuitry configured to estimate a probability distribution of a measurement of the feature of interest based on the modelled measurement data.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION OF THE DRAWINGS

Embodiments of the present invention will now be described further, with reference to the accompanying drawings, in which:

FIG. 1A and FIG. 1B comprise frames of an ultrasound in which a feature of interest is measured;

FIG. 2 illustrates graphically an idealised distribution of measurements for a measurement of a structure, element or feature of interest, with true value 30 mm;

FIG. 3 illustrates schematically some components of an arrangement according to one possible implementation; and

FIG. 4 illustrates schematically steps of a method performed in accordance with an arrangement.

### DESCRIPTION OF THE EMBODIMENTS

Before discussing embodiments in any more detail, first an overview will be provided.

Arrangements provide a technique for measuring elements, parts, components or features of a 3-dimensional object which have been imaged and which are represented in image data. Typically, those elements of the 3-dimensional object not only need to be recognised within the image data, but also those elements need to be identified or viewed in a particular orientation or in a particular imaging plane through the 3-dimensional object. For example, consider imaging a complex 3-dimensional part such as a mechanical assembly. It may be desirable not only to identify an element such as an O-ring within that mechanical assembly, but also to identify the O-ring when viewed in a plan view, rather than in a cross-sectional view. Equally, consider imaging a complex 3-dimensional part such as a human or animal body. It may be desirable not only to identify a valve of a heart, but also to identify the valve when viewed in a cross-sectional view, rather than a plan view. Having identified one or more element forming part of a 3-dimensional object, arrangements provide a mechanism according to which one or more dimension of such an element can be determined.

Take, for example, one particular case of 3-dimensional imaging in which a dimension of an element within a 3-dimensional object being imaged may have significance: biometrics such as head circumference and femur length are routinely measured in antenatal ultrasound scans to evaluate fetal growth and development. Current clinical standards require sonographers to take a small number of manual measurements of these biometrics in an ultrasound scanning session. Typically sonographers perform such measurements by freezing an image plane including an element of interest during live scanning and then using manually placed calipers or an alternative form of measurement to determine one or more dimension in relation to the element of interest within the frozen image plane. It will be appreciated that such an approach involves selection of what typically amounts to a single view or image of an element, in other words, a frozen or other user selected image plane. Once the single view is selected, a dimension or measurement is determined on the basis of the appearance of the element within that single view. In some cases, multiple measurements may be made of the element of interest, but such multiple measurements are all performed on the same single captured frozen image plane. If multiple measurements are made, at least, for example, in the case of antenatal ultrasound imaging to assess fetal growth, it is usual to select one of the multiple measurements as the value to be reported.

There are established products and methods which can assist sonographers to identify a view or plane from which they can take meaningful measurements in relation to an element or feature. One example of such an assistive technology is described in WO2018/060723A1 (KING'S COLLEGE LONDON) according to which imaging methods, imaging apparatus and computer program products are disclosed. The imaging method disclosed in that document comprises steps of: receiving image data of a 3-dimensional object; allocating a confidence level to at least a portion of an image frame of the image data using a machine-learning algorithm, the confidence level indicating a likelihood of that image frame having a specified element imaged on a specified plane through the 3-dimensional object. In this way, particular elements when imaged in a desired way can be identified from image data of the 3-dimensional object. Having identified a “best” plane including a specified element based on the allocated confidence level, measurement of the specified element on that best plane may occur in the same way as described above in relation to a single frame selected by the sonographer.

Although the degree of automation and assistance within ultrasound imaging is gradually increasing, workflows in clinic have, so far, remained as described above. Arrangements recognise that methods of biometric acquisition which rely on only one, or a very small number, of still images can lead to significant variability between different measurements.

Arrangements described herein provide a method of using or processing imaging data collected in relation to a 3-dimensional object including one or more features or elements of interest in such a way that an indication of a representative “true” value of a dimension associated with the feature or element of interest can be determined. According to some arrangements, an indication of confidence in the determined true value can be provided.

By way of example, methods such as those described in WO2018/060723A1 (KING'S COLLEGE LONDON) can be used to automatically identify a plurality of imaging planes in which an element or feature of interest can be seen. In the case of WO2018/060723A1 (KING'S COLLEGE LONDON), those planes may comprise standard fetal imaging planes in which one or more element, feature or structure of interest is present. A measurement of the element, feature or structure of interest in each identified imaging plane can be obtained.

Identification of such a plurality of imaging planes which include an element, feature or structure of interest can support, for example, an approach in accordance with described arrangements.

In an implementation using the methods of WO2018/060723A1 (KING'S COLLEGE LONDON) is such that, from a block of 3-dimensional imaging data, a plurality of imaging planes containing an element, feature or structure of interest can be identified. from that plurality of imaging planes, hundreds of distinct measurements of the element, feature or structure may be generated. For example, such relevant imaging data may be processed such that automatic measurement of a biometric in relation to an element or feature of interest may be obtained for each relevant frame/plane of the 3-dimensional scan imaging data.

In other words, techniques may be used to generate hundreds of distinct measurements in relation to one block of 3-dimensional imaging data from a scan.

There is likely to be variation across the plurality of measurements of obtained in relation to a dimension of an element, structure or feature of interest, which raises the question of how to obtain a meaningful “true” value of the biometric from them.

It will be appreciated that an approach in accordance with the arrangements described in more detail below does not depend on the approach described in WO2018/060723A1. It does not even, strictly speaking, depend on provision of an imaging dataset or frames of an imaging dataset: all it needs is a stream of measurements derived from imaging data that follow distributions as described. Approaches in accordance with described arrangements do, however, typically utilise a substantial number of measurements in order to be useful and meaningful. It will be appreciated that applying an approach in accordance with described arrangements to a small number of available measurements may result in a representative “true” value which is very close to the chosen prior or somewhat spurious.

Described arrangements relate to an apparatus and method configured to provide a mechanism to estimate a “true” value of a measurement, for example, a biometric, from a set of indications of that measurement. The indications of the measurement may comprise measurements obtained from imaging data, for example, medical imaging data. In particular, one implementation of described arrangements relates to an apparatus and method configured to estimate a true value from a set of measurements of one or more element, part, component or feature of a 3-dimensional object which have been imaged and which are represented in image data. Accordingly, approaches may provide an improved mechanism to identify and provide an accurate measurement of an element, feature or structure from imaging data relating to a 3-dimensional object.

Arrangements described relate to a Bayesian approach which supports obtaining an estimate of a “true” value of a biometric from a set of noisy measurements. Some described arrangements may provide an indication of a credibility interval in relation to a determined “true” value.

Accordingly, a general approach adopted in accordance with arrangements described operates to model a measurement distribution as a superposition of two distributions:
1) a “truth” distribution of imprecise measurements of a correct structure, element or feature, which, in some implementations, is modelled as a Gaussian distribution around the true biometric, and
2) a “noise” distribution of metrics from misclassified structures, which, in some implementations, is modelled as a uniform distribution over a search space.

It will be appreciated that the model selected for each distribution may be selected in dependence upon one or more characteristic or nature of a data stream, representing the set of noisy measurements, upon which the approach is implemented. In general, for example, although described in the example below in relation to a Gaussian and a uniform distribution to model true measurements and noise values respectively, the approaches described will be understood to be easily extensible to other probability distributions, provided they are tractable by a Bayesian method.

In accordance with arrangements, for each measurement sample, a posterior probability of it belonging to either of the distributions set out above is calculated. An estimate of the truth distribution can then be updated based on a likelihood of the measurement being a true measurement. It will be appreciated that, in accordance with some implementations, relative weights of the truth and noise distributions can be updated in real time.

Accordingly, arrangements may support reporting of a central estimate of the truth value. That central estimate can be obtained in real time, together with a standard error related to the variance of the truth distribution and the number of samples observed. The central estimate reported offers a representative indication of a ground truth measurement, supporting an accurate indication of a measurement associated with an element, structure or feature which appears in captured image data.

Having described an approach in general overview, more detail about features of various possible implementations of such an approach are provided.

### Data Selection and Pre-Processing

It will be appreciated that, in general, approaches described herein may be applied to non-biological applications as well as biological applications. Measurements of elements or features of interest in the biological field are typically referred to, in the context of the imaging of biological material as “biometrics”. Possible applications of approaches are described in relation to example biological applications.

As described above, a standard clinical protocol for a routine prenatal ultrasound scan involves finding and observing a defined set of standard planes and measuring one or more feature or element shown in those planes. Standard planes are used to observe fetal anatomy in a standardised way that is then comparable across scans. In terms of fetal imaging, each standard plane involves a certain anatomical feature that is imaged from a certain angle. In clinical practice, a sonographer finds a standard plane manually and saves a screenshot of that plane for production of a report.

As referenced above, it is possible to acquire imaging data in different, non-traditional, ways. For example, it may be possible to record a full set of data acquired during an ultrasound session, rather than recording just one or more standard planes known to be of interest. Systems such as Sononet [1] can be used to detect standard planes from imaging data captured during an ultrasound scan without any manual input from the sonographer. The approach described in Sononet comprises a convolutional neural network (CNN) trained on video recordings of thousands of ordinary ultrasound scans. Sononet can process every frame of image data captured as a result of an ultrasound scan and output which (if any) standard plane each frame belongs to. It has a classification accuracy of 85-95%, depending on the specific standard plane under consideration.

### Biometric Measurement

Some standard planes, for example, the femur plane in relation to prenatal fetal scans, contain a biometric that, in accordance with clinical protocol, has to be measured during the ultrasound scan. Such a biometric may, for example, comprise, fetal femur length.

In clinical practice, once a sonographer has taken a screenshot of the relevant standard plane, they manually measure the ends of the feature or structure. This is only done for images in a standard plane.

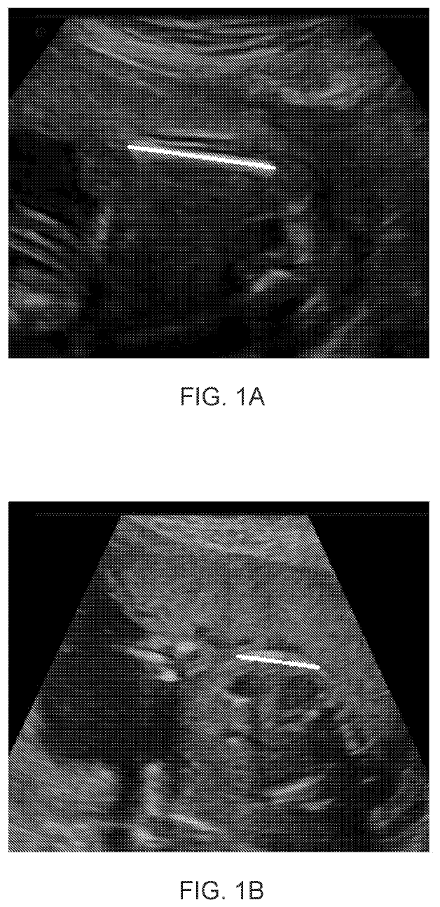

FIG. 1A and FIG. 1B comprise frames of an ultrasound in which a feature of interest is measured. FIG. 1A shows a measurement of interest being taken in accordance with methods described below in relation to an image correctly classified as containing a fetal femur. FIG. 1B shows a measurement of interest being taken in accordance with methods described below in relation to an image incorrectly classified as containing a fetal femur.

To obtain such measurements from a set of frames of interest (for example, identified by a system such as Sononet), one possibility is to use another neural network, for example, a U-Net [2], to predict measurement of a feature in the frame(s). For example, a U-Net may be configured to predict endpoints of a structure, element or feature in a frame which a sonographer would label (see FIG. 1A). With such a prediction of endpoints, it is straightforward to measure the distance therebetween to obtain an indication of a biometric comprising a distance between the two endpoints. According to some implementations of approaches, a separate neural network may be trained to recognise an endpoint(s) or other measurement anchor(s) in relation to each biometric of interest. An appropriate neural network may be trained on, for example, thousands of manual measurements relating to a biometric of interest.

Implementation of some arrangements may be such that, for a plurality of frames or planes, a feature of interest can be identified and an associated measurement obtained. In relation to, for example, the Sononet frames referred to above, one implementation of methods may be such that a measurement or measurements relating to a feature, element, or structure of interest can be determined for every frame of an ultrasound video classified as relating to a particular standard plane.

Since the Sononet standard plane classification occasionally misfires and misclassifies a plane, sometimes a measurement is demanded or made in relation to an image that does not belong to a standard plane.

Since biometric measurement neural networks in accordance with described approaches are typically trained only on views known to be of a relevant standard plane, the output of the biometric neural network (when presented with a non-standard image) can unpredictable. The biometric measurement network may, for example, often still output a measurement, but that measurement may comprise a substantially meaningless measurement from spurious endpoints (see FIG. 1B).

Spurious feature measurement may add some noise to a set of measurements. However, it will be appreciated that it is possible to filter some such spurious feature measurements from a measurement set. In particular, while measurements from correctly classified images will be close to, or clustered around, a true femur length, whereas any measurements derived from an incorrectly classified image are likely to be more random. According to some implementations, it is possible to filter a set of measurements relating to a structure, feature or element to remove any measurements that represent an impossible or highly improbable measurement of a feature, element or structure of interest. For example, in relation to fetal femur length or similar biometric, filtering may take place to remove measurements from an input data set which represent measurements which are biologically impossible.

That is to say, in relation to a structure, element or feature of interest, a method may be implemented according to which any measurements outside of a range [a, b] (where a and b are the lower and upper bounds of a length range any realistic measurements will fall into) can be automatically discarded without further processing.

Arrangements may be such that they are configured to probabilistically reject some readings and/or downweight (or exclude) them from an overall estimate of a measurement of the feature of interest.

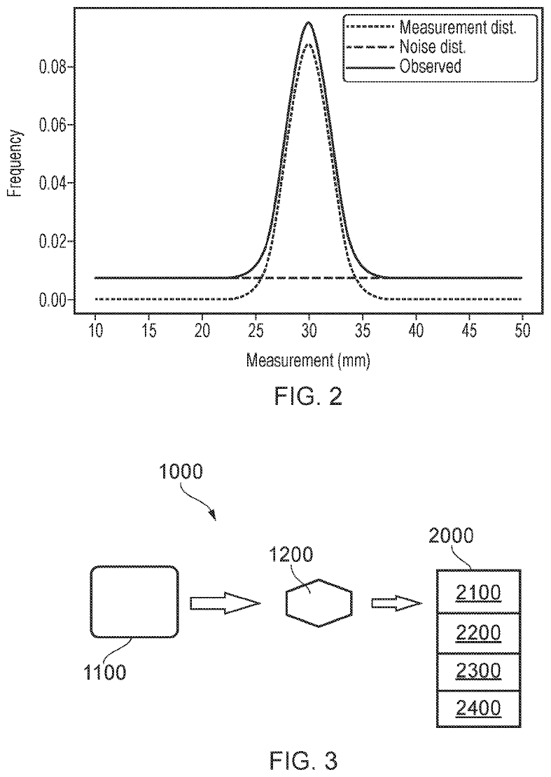

FIG. 2 illustrates graphically an idealised distribution of measurements for a measurement of a structure, element or feature of interest, with a true value of 30 mm.

The observed distribution of measurements is a sum of a measurement distribution and a noise distribution.

Arrangements recognise that repeated measurements of the same element, feature or structure, for example, a biometric across different frames of a standard plane, should differ only slightly, and, in general should be expected to cluster around a mean.

According to some arrangements, it can be assumed that measurements of a feature, element or structure follow a normal distribution:

N(μ,σ²)
where:
μ is the mean of the distribution (if unbiased, this should be the same as a “true” value for the measurement); and
σ² is its variance (which depends on the precision of the measurements).

However, since the standard plane detection method is imperfect, some misclassified planes also return a measurement. Since such planes do not contain the element, structure or feature of interest, and since the measurement network has not been trained on such data, the output from a measurement derived from such a plane essentially comprises a random length within the range [a, b] (where a and b are the lower and upper bounds of a length range any realistic measurements will fall into). That type of noise can be modelled as a uniform distribution U (a, b).

Thus, the observed distribution Dₒ of measurements will be a weighted sum of the measurement distribution N (μ, σ²) relating to, for example, correctly classified standard planes and a noise distribution U (a, b) (for structure or plane misclassifications). The observed distribution can therefore be considered to be:

Dₒ=PₜN(μ,σ²)+(1−Pₜ)U(a,b) [1]

where Pₜ represents the proportion of measurements that come from the true measurement distribution.

This equation contains several unknowns Pt, μ, σ² which, approaches seek to estimate iteratively using a Bayesian approach.

Pₜ is not known a priori: it typically depends on the measurement of interest, for example, biometric, and on the proportion of measurements from misclassifications which have been determined to be within the bounds [a, b].

To initialise a Bayesian estimation, an estimate is initialised at a prior value. According to some approaches, an initialisation value of Pₜ₀=0.5 can be selected for all measurements. It will be appreciated that whichever initialisation value is chosen, the estimation process is configured such that it converges on a true value from any starting point that is not 0 or 1. The prior value is also given a weight W₀, which is another configurable parameter which may vary in accordance with a selected implementation of described approaches. The estimate should converge on the true value of Pₜ regardless of what W₀ is set to, but setting it too high can cause it to converge slowly, whilst setting it too low can cause the estimate of Pₜ to oscillate inappropriately.

For each new measurement xᵢ which forms part of a dataset, it is possible to estimate the likelihood of it being a “true” measurement T or noise T.

It is possible to apply Bayes' rule:

$$P ( T \vert {x}_{i} ) = \frac{P ( {x}_{i} \vert T ) {P}_{t}}{P ( {x}_{i} \vert T ) ( 1 - {P}_{t} )} \qquad [ 2 ]$$

where
P(xᵢ|T) is the value of the normal probability density function N (μ, σ²) at xᵢ; and P(xᵢ|T) is the value of the uniform probability density function U (a, b) at value xᵢ. This returns P (T|xᵢ), which is the probability that the measurement was sampled from the true measurement distribution.

It is then possible to update Pₜ for a given measurement of an element, feature or structure based on the calculated likelihood. This can be done using a weighted sum:

If xᵢ is the ith measurement of a particular element, structure or feature, then it is possible to update the estimate of Pₜ using the rule:

$${P}_{ti} = P ( T \vert {x}_{i} ) + {W}_{i - 1} {P}_{ti - 1}$$

Wᵢ₋₁+1 [3]

and update weighting of the estimate to

Wᵢ=Wᵢ₋₁+1 [4]

### Estimating Distribution Parameters

A similar approach can be used to estimate the measurement distribution parameters μ and σ².

Prior estimates of these values μ₀ and σ₀² are set, along with appropriate prior weights W_{μ,0} and W_{σ2,0}.

Now for each new measurement xᵢ, the estimates of the measurement distribution parameters can be tweaked, weighted by the likelihood this is a true measurement P(T|xᵢ):

$${μ}_{i} = \frac{{x}_{i} P ( T \vert {x}_{i} ) + {W}_{μ , i - 1} {μ}_{i - 1}}{P ( T \vert {x}_{i} ) + {W}_{μ , i - 1}} \qquad [ 5 ]$$

$${σ}_{i}^{2} = \frac{{( {x}_{i} - {μ}_{i - 1} )}^{2} P ( T \vert {x}_{i} ) + {W}_{{σ}^{2} , i - 1} {σ}_{i - 1}^{2}}{P ( T \vert {x}_{i} ) + {W}_{{σ}^{2} , i - 1}} \qquad [ 6 ]$$

and the weights can be updated using

W_{μ,i}=W_{μ,i-1}+P(T|xᵢ) [7]

W_{σ}_{²}_{,i}=W_{σ}_{²}_{,i-1}+P(T|xᵢ) [8]

Since the noise distribution is taken to be uniform in the described implementation, there is no need to update estimates of its terms.

The estimates for μ and σ² can be updated in real time and independently for each measurement of a structure, element or feature of interest. At any given moment, the estimate of μ represents the best estimate of the true value of the measurement of interest, assuming an unbiased set of measurements.

Meanwhile, the estimate of σ² forms part of a calculation of the error margin to assign to the measurement of interest. It will be appreciated that the error margin will be based upon the standard error of the mean, and also the number of measurements that have been processed as part of the process.

It will further be appreciated that there are some design parameters that can be tweaked, such as the shape of distributions chosen: use of a normal distribution for true measurements and a uniform distribution for noise is described since they are tractable for easy computation and give good performance on biometric data upon which the approach has been developed, but it is possible to apply the general approach described to different assumed distributions.

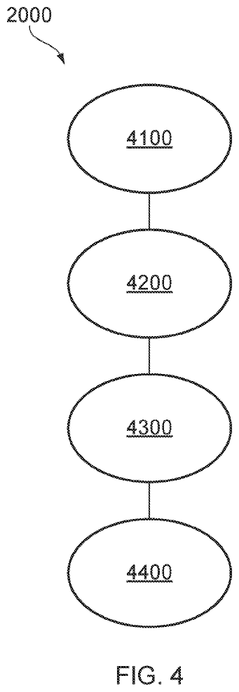

FIG. 3 illustrates schematically some components of an arrangement according to one possible implementation; and FIG. 4 illustrates schematically steps of a method performed in accordance with an arrangement.

FIG. 3 illustrates schematically some components of a system 1000 including an apparatus 2000 according to some arrangements. The system 1000 comprises an imaging device, for example an ultrasound scanner, MRI scanner or similar 1100, configured to generate imaging data 1200 relating to images of a 3-d object including or comprising an element or structure of interest. That data can be provided, in real time, or otherwise, to apparatus 2000. Apparatus 2000 may comprise a computing device.

Apparatus 2000 comprises:
means 2100 configured to acquire measurement data relating to a structure of interest from imaging data representative of a three-dimensional object comprising the feature of interest;
means 2200 configured to model measurement data distribution as a superposition of: a truth distribution of imprecise measurement of the feature of interest, and a noise distribution;
means 2300 configured to assume a first shape for the truth distribution and a second shape for the noise distribution; and
means 2400 configured to estimate a probability distribution of a measurement of the feature of interest based on the modelled measurement data.

FIG. 4 illustrates schematically steps of a method performed in accordance with an arrangement.

The apparatus 2000 may be configured to perform a method comprising the steps of:
4100: acquiring measurement data relating to a feature of interest from imaging data representative of a three-dimensional object comprising the feature of interest;
4200: modelling measurement data distribution as a superposition of: a truth distribution of imprecise measurement of the feature of interest, and a noise distribution;
4300: assuming a first shape for the truth distribution and a second shape for the noise distribution; and
4400: estimating a probability distribution of a measurement of the feature of interest based on the modelled measurement data.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

### REFERENCES

(1) Christian F. Baumgartner, Konstantinos Kamnitsas, Jacqueline Matthew, Tara P. Fletcher, Sandra Smith, Lisa M. Koch, Bernhard Kainz, and Daniel Rueckert. Sononet: Real-time detection and localisation of fetal standard scan planes in freehand ultrasound. IEEE Transactions on Medical Imaging, 36, 2017.
(2) Olaf Ronneberger, Philipp Fischer, and Thomas Brox. U-net: Convolutional networks for biomedical image segmentation. volume 9351, 2015.

1. An apparatus comprising:
at least one processor; and at least one memory storing instructions which, when executed by the at least one processor, cause the apparatus to:
acquire measurement data relating to a feature of interest from imaging data representative of a three-dimensional object comprising the feature of interest;
model a measurement data distribution as a superposition of:
a truth distribution of imprecise measurement of the feature of interest, and a noise distribution;
assume a first shape for the truth distribution and a second shape for the noise distribution; and
estimate a probability distribution of a measurement of the feature of interest based on the measurement data distribution.

2. The apparatus of claim 1, wherein the measurement data relates to a biometric of the feature of interest from imaging data representative of a three-dimensional object comprising the feature of interest.

3. The apparatus of claim 1, wherein the apparatus is configured to estimate a measurement of the feature of interest based upon an estimated probability distribution of measurements of the feature of interest based on the measurement data distribution, the measurement being derived from a central measurement of the estimated probability distribution.

4. The apparatus of claim 1, wherein the truth distribution of imprecise measurement of the feature of interest has a first shape modelled as a Gaussian distribution around the measurement.

5. The apparatus of claim 1, wherein the noise distribution is attributable to data from misclassified features that have a second shape modelled as a uniform distribution over a search space.

6. The apparatus of claim 1, wherein the instructions, when executed by the at least one processor, further cause the apparatus to estimate a probability distribution of a measurement of the feature of interest based on the measurement data distribution by calculating, for each measurement sample of the measurement data, a posterior probability of a measurement sample belonging to either the truth distribution or the noise distribution.

7. The apparatus of claim 6, wherein an estimate of the truth distribution is updated based on a likelihood of a measurement sample of the measurement data being a true measurement.

8. The apparatus of claim 1, wherein relative weights of the truth distribution and the noise distribution can be updated.

9. The apparatus of claim 1, configured to estimate a probability distribution of a measurement of the feature of interest based on the measurement data distribution by applying a Bayesian inference approach.

10. The apparatus of claim 1, wherein the instructions, when executed by the at least one processor, further cause the apparatus to analyse the measurement data and discard any measurement which falls outside a preselected range associated with the feature of interest.

11. The apparatus of claim 1, wherein the instructions, when executed by the at least one processor, further cause the apparatus to filter some measurement data from a data measurement set to remove any measurement that represents an improbable measurement of the feature of interest.

12. The apparatus of claim 10, wherein any measurement within the measurement data outside of a range [a, b], where a and b are lower and upper bounds of a range selected in dependence upon the feature of interest, is discarded without further processing.

13. The apparatus of claim 1, wherein the measurement data comprises measurement of a biometric relating to a feature of interest in ultrasound imaging data.

14. The apparatus of claim 1, wherein the instructions, when executed by the at least one processor, further cause the apparatus to acquire the measurement data by analysing one or more image of the feature of interest obtained from the imaging data representative of a three dimensional object.

15. The apparatus of claim 14, wherein the one or more image comprises a standard frame obtained from ultrasound imaging data.

16. The apparatus of claim 14, configured to recognise one or more measurement anchor in an image comprising the feature of interest and determine a measurement of the feature of interest from the one or more measurement anchor.

17. The apparatus of claim 16, configured to use a neural network trained to recognise the one or more measurement anchor in the image comprising the feature of interest.

18. A computer-implemented method comprising:
acquiring measurement data relating to a feature of interest from imaging data representative of a three-dimensional object comprising the feature of interest;
modelling a measurement data distribution as a superposition of:
a truth distribution of imprecise measurement of the feature of interest, and
a noise distribution;
assuming a first shape for the truth distribution and a second shape for the noise distribution; and
estimating a probability distribution of a measurement of the feature of interest based on the measurement data distribution.

19. A non-transitory computer readable medium storing executable instructions which, when executed by a processing device, cause the processing device to perform operations comprising:
acquiring measurement data relating to a feature of interest from imaging data representative of a three-dimensional object comprising the feature of interest;
modelling a measurement data distribution as a superposition of:
a truth distribution of imprecise measurement of the feature of interest, and
a noise distribution;
assuming a first shape for the truth distribution and a second shape for the noise distribution; and
estimating a probability distribution of a measurement of the feature of interest based on the measurement data distribution.
